(19) United States
(12) Patent Application Publication
(10) Pub. No.: US 2023/0122584 A1
(43) Pub. Date: Apr. 20, 2023

(54) LABEL CONSTRUCTIONS FOR WET APPLICATIONS

(71) Applicant: Avery Dennison Corporation, Mentor, OH (US)

(72) Inventors: Yijun YE, Solon, OH (US); Katia C. LOHN, Beachwood, OH (US); Peter R. VON KLEIST, Alta Loma, CA (US); Vanita D. MARZETTE, Solon, OH (US)

(21) Appl. No.: 17/724,761

(22) Filed: Apr. 20, 2022

Related U.S. Application Data
(60) Provisional application No. 63/256,181, filed on Oct. 15, 2021.

(51) Int. Cl. G09F 3/02; G09F 3/10

(52) U.S. Cl. CPC G09F 3/02; G09F 3/10; G09F 2003/0257; G09F 2003/023

(57) ABSTRACT

Label constructions exhibiting improved ice bucket performance, wet and/or dry opacity, delta opacity, show through, adhesive strength, and/or channeling/label movement are described herein. In some embodiments, the construction has a delta opacity is less than or equal to 10%. The label constructions described herein can be used on a variety of different substrate materials including glass and plastic. In some embodiments, the label constructions are used on glass, such as glass bottled, e.g., wine, beer, and spirits bottles. In some embodiments, the label constructions described herein are used on beverage bottles that are likely to be immersed in water, particularly cold water, for an extend period of time.

### CROSS-REFERENCE TO RELATED APPLICATION

The present application claims the benefit of U.S. Provisional Application No. 63/256,181 filed Oct. 15, 2021, which is incorporated herein by reference in its entirety.

### FIELD

The present application relates to label constructions for use in wet applications, particularly lower temperature, wet applications.

### BACKGROUND

The attractiveness of some products, such as wines and spirits, depends upon the ongoing good appearance of labels present on the outside of the container containing the product. This is particularly true for those wines and spirits that might normally be subjected to moisture during cooling or being kept cool.

While coated papers have been used for the production of labels for wine and spirits, the appearance of uncoated labels is often preferred to achieve the desired aesthetic. Uncoated papers, however, can suffer from performance limitations. For example, where the uncoated paper surface is subjected to humidity or liquid over a period of time, infusion of the liquid into the paper typically causes the appearance of the paper to change and the paper may also pucker. Furthermore, when an uncoated label is exposed to moisture for some time, the label may become completely saturated and, due to the inherent composition of paper, may become susceptible to damage as it becomes fragile. If the damage is significant, the label may be aesthetically deficient. Finally, as the label becomes saturated, it then loses opacity, which affects the visual appearance of not only the label, making it difficult to read, but also detracts from the overall appearance of the bottle itself.

In addition to the limitations described above, under some conditions, the moisture can affect the adhesive holding the label to the bottle, such that the label will become detached from the bottle making identification of the contents difficult.

Even though the label itself may not separate from the container to which it is attached under such wet conditions, nonetheless it is considered highly disadvantageous for a label to change its appearance and/or become fragile as this adversely affects the design aesthetic as well as brand reputation.

There exists a need for label constructions with improved wet and dry opacity, reduced delta opacity, improved water resistance and adhesive strength, and improved color, whiteness, and brightness.

### BRIEF DESCRIPTION OF THE DRAWINGS

FIG. 1 is an example of Prototype 1, a multilayer construction described herein.

FIGS. 2A and 2B are examples of Prototype 2, a multilayer construction described herein.

FIG. 3 is an example of Prototype 3, a multilayer construction described herein.

FIG. 4 is an example of Prototype 4, a multilayer construction described herein.

FIG. 5 is an example of Prototype 5, a multilayer construction described herein.

FIG. 6 is a graph showing wet opacity, dry opacity, and delta opacity for various constructions.

FIG. 7 is a graph showing water resistance (mm) as a function of time (hours) for various constructions.

FIG. 8 is a graph showing water resistance (mm) as a function of time (hours) for various constructions.

FIG. 9 is a graph showing water resistance (mm) as a function of time (hours) for various constructions.

FIG. 10 is a graph showing water resistance (mm) as a function of time (hours) for various constructions.

FIG. 11 is a graph showing water resistance (mm) as a function of time (hours) for various constructions.

### SUMMARY

Label constructions exhibiting improved ice bucket performance, wet and/or dry opacity, delta opacity, show through, adhesive strength, and/or channeling/label movement are described herein.

In some embodiments, the constructions contain a facesheet; a first adhesive layer adjacent to the face sheet; a foil layer; a topcoat adjacent to the foil layer; a second adhesive adjacent to the topcoat; and a liner adjacent to the second adhesive layer.

In other embodiments, the construction is prototype 1, which contains a face sheet; an optional (white) polyolefin (polyethylene) layer adjacent to the face sheet; a (grey) polyolefin (polyethylene) layer adjacent to the first face sheet or the (white) polyolefin (polyethylene) layer; a second (white) polyolefin (polyethylene) layer adjacent to the (grey) polyolefin (polyethylene) layer; an adhesive layer adjacent to the second (white) polyolefin (polyethylene) layer; and a liner.

In some embodiments, the facesheet in prototype 1 contains or is a paper, such as a cellulosic or natural paper or a synthetic paper.

In some embodiments, the facesheet in prototype 1 is as defined above, and the white and grey polyolefin layers contain or are polyethylene homopolymers and/or copolymers. In some embodiments, the polyethylene copolymer is derived from ethylene monomer and one or more other alkylene monomers. Monomers, other than alkylene monomers, may also be incorporated therein.

In some embodiments, the facesheet and the white and grey layers in prototype 1 are as described above, and the adhesive is a pressure sensitive adhesive (PSA).

In some embodiments, the facesheet, white and grey layers, and PSA in prototype 1 are as described above and the liner is a polyester, such as PET.

In some embodiments, the construction of prototype 1 consists essentially of a face sheet, a first white polyolefin layer, a grey polyolefin layer, a second white polyolefin layer, an adhesive layer, and a liner wherein these components are as described above.

In some embodiments, the construction of prototype 1 consists of a face sheet, a first white polyolefin layer, a grey polyolefin layer, a second white polyolefin layer, an adhesive layer, and a liner wherein these components are as described above.

In still other embodiments, the construction is prototype 2, which contains a face sheet; a (weld) adhesive layer adjacent to the face sheet; a metallized polyolefin layer adjacent to the adhesive layer; a (white) second adhesive layer adjacent to the metallized polyolefin layer; a third adhesive layer adjacent to the second adhesive layer; and a liner adjacent to the third adhesive layer. In some embodiments, the polyolefin layer is a polyolefin homopolymer and/or copolymer. In some embodiments, the polypolefin copolymer is derived from two or more alkylene monomers. Monomers, other than alkylene monomers, may also be incorporated therein.

In still other embodiments, the construction contains a face sheet; a topcoat adjacent to the face sheet; a white polyolefin layer adjacent to the topcoat; an adhesive layer adjacent to the white polyolefin layer; and a liner adjacent to the adhesive layer. In some embodiments, the polyolefin layer is a polyolefin homopolymer and/or copolymer. In some embodiments, the polypolefin copolymer is derived from two or more alkylene monomers. Monomers, other than alkylene monomers, may also be incorporated therein.

The constructions described herein can contain a facesheet as described herein, one or more polyolefin or metallized polyolefin layers as described herein, one or more adjacent adhesive layers as described herein and a liner. In some embodiments, the constructions consist essentially of these components as described herein. In some embodiments, the construction consists of these components as described herein. In some embodiments, the polyolefin layer is a polyolefin homopolymer and/or copolymer. In some embodiments, the polypolefin copolymer is derived from two or more alkylene monomers. Monomers, other than alkylene monomers, may also be incorporated therein.

In some embodiments, the construction is as described above and exhibits a dry opacity greater than or equal to about 90%, 91%, 92%, 93%, 94%, 95%, 96%, 97%, 98%, or 99%.

In some embodiments, the construction is as described above, exhibits the dry opacity described above, and a wet opacity greater than or equal to about 80%, 81%, 82%, 83%, 84%, 85%, 86%, 87%, 88%, 89%, 90%, 91%, 92%, 93%, 94%, 95%, 96%, 97%, 98%, or 99%.

In some embodiments, the construction is as described above, having the dry opacity and wet opacity described above and the delta opacity is less than or equal to about 10%, 9.5%, 9.0%, 8.5%, 8.0%, 7.5%, 7.0%, 6.5%, 6.0%, 5.5%, 5.0%, 4.5%, 4.0%, 3.5%, 3.0%, 2.5%, 2.0%, 1.5%, 1.0%, 0.9%, 0.8%, 0.7%, 0.6%, 0.5%, 0.4%, 0.3%, 0.2%, or 0.1%.

In some embodiments, the construction is as described above, having the dry opacity, wet opacity, and delta opacity described above and exhibits water intrusion of less than or equal to about 20 mm, 19 mm, 18 mm, 17 mm, 16 mm, 15 mm, 14 mm, 13 mm, 12 mm, 11 mm, 10 mm, 9 mm, 8 mm, 7 mm, 6 mm, 5 mm, 4 mm, 3 mm, 2 mm, or 1 mm.

The label constructions described herein can be used on a variety of different substrate materials including glass and plastic. In some embodiments, the label constructions are used on glass, such as glass bottled, e.g., wine, beer, and spirits bottles. In some embodiments, the label constructions described herein are used on beverage bottles that are likely to be immersed in water, particularly cold water, for an extend period of time, e.g., greater than about 1, 2, 3, 4, 5, 6, 7, 8, 9, 10, 12, 14, 16, 18, 20, 25, 30, 35, 40, 45, 50, 55, 60, 65, 70, or 75 hours.

### I. Definitions

“Adhesive strength” or “adhesive tightness”, as used herein, refers to a qualitative assessment of adhesive strength of a label construction on a substrate.

“Brightness”, as used herein, typically refers to a material's (e.g., paper's) ability to reflect a single wavelength of light (e.g., 457 nm).

“Delta opacity”, as used herein, means the difference between the dry opacity and the wet opacity.

“Dry opacity”, as used herein, refers to the quantitative measurement of the opacity of a facestock or label construction under dry conditions.

“Edge lift”, as used herein, is a qualitative measurement of adhesive strength and water intrusion.

“Label shift”, as used herein, refers to a qualitative assessment of label position on a substrate after immersion in a water bath.

“Show through”, as used herein, refers to a qualitative, visual observation of the amount/area of a facestock or construction that is wet. A lower percentage observation indicates greater opacity.

“Wet opacity”, as used herein, refers to the quantitative measurement of the opacity of a facestock or label construction under wet conditions.

“Whiteness”, as used herein, refers to a material's (e.g., paper's) ability to equally reflect a balance of all wavelengths of light across the visible spectrum (e.g., 380 nm-720 nm).

### II. Constructions

Constructions that exhibit improved wet and dry opacity, adhesive strength when submerged or exposed to cold water, water resistance, color, whiteness, and brightness are described herein. The individual components of the constructions, and their properties, are discussed in more detail below. However, in some embodiments, the total thickness of the construction is from about 70 to about 175 microns, from about 80 to about 160 microns, from about 90 to about 150 microns, from about 95 to about 140 microns, from about 100 to about 135 microns or from about 100 to about 130 microns. In some embodiments, the total thickness of the construction is about 100 microns, 105 microns, 110 microns, 115 microns, 120 microns, 125 microns, 130 microns, 135 microns, or 140 microns.

A. Face Sheet or Face Stock

The outer most layer (i.e., layer further from the object to which the label is attached) of the constructions described herein in referred to as the face sheet. The face sheet can contain, or be made from, any suitable material or materials. In some embodiments, the face sheet contains, is made from, or is a paper. In some embodiments, the face sheet is a cellulosic paper or natural paper. In other embodiments, the face sheet is a synthetic paper. “Synthetic paper” as used herein refers to materials manufactured using synthetic resins that have properties similar or comparable to natural paper. In some embodiments, the synthetic resins are or contain one or more polyolefins, such as polyethylene, polypropylene, and combinations thereof.

In some embodiments, the facestock is the thickest layer in the construction. In some embodiments, the thickness of the facestock is from about 60 microns to about 170 microns, from about 60 microns to about 150 microns, from about 60 microns to about 130 microns, from about 65 microns to about 120 microns, from about 70 microns to about 100 microns. In some embodiments, the thickness of the facestock is from about 70 microns to about 80 microns, from about 70 to about 75 microns, or from about 70 to about 73 microns.

B. Topcoat

In some embodiments, the constructions described herein contain a topcoat. In some embodiments, the topcoat is adjacent to the face sheet. In some embodiments, the topcoat is in direct contact, in whole or in part, with the face sheet. In such embodiments, the topcoat can be coated onto, or co-extruded with, the face sheet or vice versa. In other embodiments, the topcoat is adhered to the face sheet via an adhesive layer. In some embodiments, the adhesive layer is coated onto the face sheet and/or the topcoat.

The thickness of the topcoat can vary as need for a particular construction. In some embodiments, the thickness of the topcoat is from about 1 to about 10 microns, from about 1 to about 8 microns, from about 1 micron to about 6 microns, from about 1 micron to about 5 microns, from about 1 micron to about 4, or from about 2 microns to about 4 microns. In some embodiments, the thickness of the foil is about 2 microns. 0.1-10 but focus on less than one.

In some embodiments, the addition of a top coat improves water resistance (as measured by the water wicking test) and/or wet opacity, dry opacity, and/or delta opacity.

C. Foils or Metallized Polymeric Films

In some embodiments, the constructions described herein contain a metallic foil layer. In some embodiments, the foil layer is adjacent to the face sheet and the topcoat. In some embodiments, the foil is adhered to the face sheet via an adhesive layer. The foil can be any metallic foil. In some embodiments, the foil is aluminum foil, silver foil, or gold foil.

In other embodiments, the construction contains a metallized polymeric film layer in place of, or in addition to, the metallic foil layer. In some embodiments, the metallized polymeric film layer is a metallized polyolefin. Examples of suitable polyolefins include, but are not limited to, polyethylene, polypropylene, and combinations thereof. The polymeric film layers may be metallized with any metal. However, in some embodiments, the metal is selected from aluminum, silver, or gold. In some embodiments, the metallized polymeric film layer is adhered to the face sheet via a weld adhesive layer.

The foil layer and/or metallized polymeric film layer may be used in combination with any of the other layers described herein, such as the polyolefin layers and/or topcoats.

The thickness of the foil layer and/or metallized polymeric film can vary as need for a particular construction. In some embodiments, the thickness of the foil layer and/or metallized polymeric film is from about 20 to about 50 microns, from about 20 to about 40 microns, or from about 20 microns to about 30 microns. In other embodiments, the thickness of the facestock as described above includes the foil layer and/or metallized polymeric film. In still other embodiments, the foil layer is from about 1 to about 10 microns, from about 1 to about 8 microns, from about 1 micron to about 6 microns, from about 2 microns to about 6 microns, from about 2 microns to about 5, or from about 2 microns to about 4 microns. In some embodiments, the thickness of the foil is about 4 microns.

In some embodiments, the inclusion of a foil layer, with or without a topcoat, improves the water resistance, dry opacity, wet opacity, and/or delta opacity. In some embodiments, the inclusion of a foil layer exhibited significantly improved ice bucket performance versus constructions containing paper/topcoat without a foil layer.

D. Polyolefin Layer(s)

In some embodiments, the construction contains a face sheet, one or more polyolefin layers, and an adhesive layer and liner as described below. In some embodiments, the construction contains two polyolefin layers. In some embodiments, the construction contains three polyolefin layers. In some embodiments, the polyolefin layer is, or contains, polyethylene, polypropylene, or combinations thereof. In some embodiments, the polyolefin layer is as described above and the polyolefin layers are white or grey or combinations thereof.

In one embodiment, the construction contains a face sheet or facestock and two polyolefin layers. In one embodiment, a grey polyolefin layer is adjacent to the face sheet and a white polyolefin layer is adjacent to the grey polyolefin layer. In some embodiments, the construction is as described above and the polyolefin in both layers is, or contains, polyethylene. In some embodiments, the polyolefin layers are extruded onto the face sheet such that there is no layer between the face sheet and the first (e.g., grey) polyolefin layer. In other embodiments, a weld adhesive layer is between the face sheet and the first polyolefin layer in order to adhere the polyolefin layers to the face sheet. In other embodiments, the white polyolefin layer is adjacent to the face sheet or face stock and the grey polyolefin layer is adjacent to the white polyolefin layer.

In other embodiments, the construction contains a face sheet or face stock and three polyolefin layers. In one embodiment, a white polyolefin layer is adjacent to the face sheet or face stock, a grey polyolefin layer is adjacent to the white polyolefin layer, and a white adjacent layer is adjacent to the grey polyolefin layer. In some embodiments, the construction is as described above and the polyolefin in the three layers is, or contains, polyethylene. In some embodiments, the polyolefin layers are extruded onto the face sheet such that there is no layer between the face sheet and the first (e.g., white) polyolefin layer. In other embodiments, a weld adhesive layer is between the face sheet and the first polyolefin layer in order to adhere the polyolefin layers to the face sheet.

The thickness of the polyolefin layer(s) can vary as need for a particular construction. In some embodiments, the total thickness of the polyolefin layer(s) is from about 15 microns to about 50 microns, from about 20 to about 40 microns, from about 25 to about 35 microns, or from about 28 microns to about 32 microns. In some embodiments, the total thickness is about 30 microns. In some embodiments, the thickness of the individual polyolefin layer(s) is from about 5 microns to about 15 microns, from about 8 microns to about 12 microns or from about 9 to about 11 microns. In still other embodiments, the thickness of the individual polyolefin layer(s) is about 10 microns. Most recent SEM is 21 microns.

In some embodiments, the inclusion of an extrusion coated PO layer increased water resistance. The inclusion of a gray layer, in two- or three-layer extruded coatings maximized performance depending on coat weight.

Regarding optical properties, such as brightness/whiteness, in some embodiments, there is an improvement in whiteness when using extruded coated polyolefin versus base paper alone.

Opacity increases with extrusion coated polyolefin. Two-layer constructions exhibited a higher dry and wet and opacity. The delta opacity also decreased. Opacity also increase slightly with increasing gray layer thickness/coat weight.

Maximum ice bucket performance and opacity was observed at a coat weight of 7.8.

E. Liner and Adhesive

The constructions described herein typically contain a liner. Materials that can be used for label liners are well known in the art. Exemplary liner materials include, but are not limited to, papers, such as glassine- or kraft-based papers, filmic liners, such as polyolefin (e.g., polyethylene and/or polypropylene) liners or PET liners, and silicone liners. One purpose of the liner is to block the adhesive layer to which the liner is adhered so that the labels can be stacked without adhering to each other. The adhesive layer to which the liner is adhered can be any type of adhesive known in the art. Examples included, but are not limited to, pressure sensitive adhesives (PSAs) and/or hot melt adhesives. Such adhesives are known in the art and can be sourced from a variety of suppliers. The adhesive layer functions to adhere the construction to a substrate, such as a bottle. In some embodiments, the adhesive layer contains or is a pressure-sensitive adhesive (PSA). In some embodiments, the PSA contains or is an acrylic-based polymer or an acrylate polymer or copolymer.

The thickness of the adhesive layer can vary for the type of the construction and the location and/or function of the adhesive layer. In some embodiments, the thickness of the adhesive layer is from about 1 micron to about 10 microns, from about 2 microns to about 8 microns, from about 2 microns to about 6 microns, or from about 2 microns to about 4 microns. In some embodiments, the thickness is about 2 microns, 3 microns, or 4 microns. 18 microns. PSA is typically 15-30 microns, can be higher for durables.

### III. Properties

A. Opacity

One of the key properties of the constructions described herein is opacity. Opacity can be measured using TAPPI standard T-425. For white labels, in some embodiments, high opacity is desired not only when the construction is dry, but also when the construction is wet. Wet opacity is measured after the sample is submerged in a beaker of water for one (1) hour. The constructions described herein exhibit a high opacity and low delta opacity. For example, in some embodiments, the constructions exhibit a dry capacity of greater than or equal to about 90%, 91%, 92%, 93%, 94%, 95%, 96%, 97%, 98%, or 99%.

In some embodiments, the constructions exhibit the dry opacity described above and a wet opacity greater than or equal to about 80%, 81%, 82%, 83%, 84%, 85%, 86%, 87%, 88%, 89%, 90%, 91%, 92%, 93%, 94%, 95%, 96%, 97%, 98%, or 99%.

In some embodiments, the construction has the opacity described above, and the delta opacity (the difference between wet opacity and dry opacity) is less than or equal to about 10%, 9.5%, 9.0%, 8.5%, 8.0%, 7.5%, 7.0%, 6.5%, 6.0%, 5.5%, 5.0%, 4.5%, 4.0%, 3.5%, 3.0%, 2.5%, 2.0%, 1.5%, 1.0%, 0.9%, 0.8%, 0.7%, 0.6%, 0.5%, 0.4%, 0.3%, 0.2%, or 0.1%. In some embodiments, the wet opacity and dry opacity are greater than about 95%, 96%, 97%, 98%, or 99% and are equal or substantially equal such that the delta opacity is about, essentially 0, or is 0.

B. Label Strength

In order to evaluate label strength, several tests are commonly used including, but not limited to, ice bucket test and water intrusion (wicking).

1. Ice Chest/Bucket Test

The ice chest/bucket test evaluates the adhesive bond of a label subjected to an ice bath. The label is applied to a wine bottle filled with water. The bottle is placed in a cooler or bucket which is then filled with ice water until the label(s) are covered. The following properties are typically evaluated visually at certain time points for up to 24 hours:
Show through/Opacity
Dart Channel Length: wrinkle in the vertical direction
Dart Channel Width: wrinkle in the horizontal direction
Edge Lift

After a visual inspection, slight thumb pressure is applied to the label to check for adhesion tightness and moderate fingernail pressure is used to scratch the surface of the label to check for ink removal.

In some embodiments, the constructions described herein exhibit a show through of less than or equal to about 25%, 23%, 20%, 18%, 15%, 12%, 10%, 9%, 8%, 7%, 6%, 5%, 4%, 3%, 2%, or 1%.

In some embodiments, the constructions described herein contain the show through described above and channeling of less than or equal to about 25%, 23%, 20%, 18%, 15%, 12%, 10%, 9%, 8%, 7%, 6%, 5%, 4%, 3%, 2%, or 1%.

In some embodiments, the constructions described herein exhibit the show through and channeling described above and slight edge lift or no edge lift. In some embodiment, the constructions exhibit no edge lift.

2. Water Wicking Test

The water wicking test measure a label's water resistance as a function of time when submerged. The label is typically laminated between two thin clear polymer films and cut to a 2×2″ square. The samples are immersed in water for a set period of time and the water penetration for each edge is measured. The units of water wicking are mm: the lowest water wicking is 0 mm and the highest is 25 mm (worst water resistance).

In some embodiments, the water intrusion (wicking) is less than about 20 mm, 19 mm, 18 mm, 17 mm, 16 mm, 15 mm, 14 mm, 13 mm, 12 mm, 11 mm, 10 mm, 9 mm, 8 mm, 7 mm, 6 mm, 5 mm, 4 mm, 3 mm, 2 mm, or 1 mm. In some embodiments, the water intrusion (wicking) is less than 5 mm, 4 mm, 3 mm, 2 mm, or 1 mm.

In some embodiments, the construction exhibits the water intrusion described above in combination with the wet opacity, dry opacity, delta opacity, show through, channeling, and/or edge lift described above.

3. Other Properties

i. Whiteness

Whiteness can be measured using a variety of techniques known in the art. For example, whiteness can be measured using ISO 11475:2004, also known as CIE whiteness; TAPPI T 560 (d/0° geometry, illuminant C/2°); TAPPI T 562 (45°/0° geometry, illuminant C/2°); ISO 11476 (d/0° geometry, illuminant C/2° observer); and ISO 11475 (d/0° geometry, CIE standard illuminant D65/10° observer).

Brightness quantifies the percentage of blue light reflected from the surface of paper as measured at a specific effective wavelength of 457 nanometers (with a half-peak bandwidth of 44 nm). The presence of optical brighteners can result in brightness values greater than 100% for the reasons discussed below.

In some embodiments, the constructions described herein exhibit a whiteness measurement greater than or equal to about 80%, 85%, 90%, 91%, 92%, 93%, 94%, 95%, 96%, 97%, 98%, 99%, 100%, 101%, 102%, 103%, 104%, 105%, 106%, 107%; 108%, 109%, 110%, 111%, 112%, 113%, 114%, 115%, 116%, 117%, 118%, 119%, 120%, 121%, 122%, 123%, 124%, 125%, 126%, 127%, 128%, 129%, 130%, 131%, 132%, 133%, 134%, 135%, 136%, 137%, 138%, 139%, 140%, 141%, 142%, 143%, 144%, or 145% or greater.

ii. Brightness

Brightness does not indicate the color or relative shade of the paper since a single number reflective value measured at 457 nm ignores all other wavelengths of light reflected across the visible spectrum. A brighter paper, therefore, reflects a greater amount of blue light than does the surface of a less bright paper. Three different brightness measurement methodologies are used worldwide. Each of these methods will produce a different brightness number when used to measure the same paper sample.

TAPPI Official Test Method T452: TAPPI T 452 brightness is often referred to as GE brightness. When measuring GE brightness, the paper sample is illuminated with a CIE illuminant C defined light source; a simulated daylight illuminant containing a certain amount of U.V. energy. In-line “brightness” filters are also applied which modify the spectral characteristics of the reflected illuminant. TAPPI T 452 specifies directional illumination/measurement geometry of 45° illumination and 0° observation (i.e., 45°/0°). In other words, the test instrument emits light which strikes the surface of the paper at a 45° angle of incidence. A photocell receptor is positioned at the N or 0° position, perpendicular to the paper sample.

ISO Brightness (ISO 2470-1): The ISO paper brightness measurement system, as defined by ISO 2470-1 and TAPPI T 525, is used for specification of paper brightness throughout Europe and in many other parts of the world. When measuring ISO brightness, the paper sample is illuminated with a CIE illuminant C light source; a daylight illuminant containing a certain amount of U.V. energy. This is the same illuminant used by the TAPPI T452/GE paper brightness measurement system.

ISO 2470-1 specifies an illumination/reflected light measurement system which utilizes diffuse optical geometry (diffuse illumination and 0° observation; i.e., d/0°). The instrument used to measure ISO brightness illuminates the samples with light projected by two lamps into an integrating sphere. The interior wall of the sphere is coated with a highly reflective non-glossy material which allows the light to inter-reflect and illuminates the paper sample from all directions; i.e., diffusely. Diffuse measurement geometry integrates the light reflected across nonuniformities of the sample and averages the effects of reflective differences due to paper directionality. Therefore, ISO brightness measurements are less sensitive to paper surface and directional orientation irregularities.

Unlike the TAPPI T 452/GE method, the ISO brightness measurement system quantifies the actual percentage of light reflected from the sample at 457 nm rather than relating measurements to a scale correlated to the percentage of light reflected by an external standard.

The ISO brightness methodology typically produces a higher brightness number than the TAPPI T 452/GE method when measuring the same paper sample due to slightly greater fluorescence stimulation, the illumination/light measurement geometry, and the brightness scales used.

D65 Brightness (ISO 2470-2): The D65 brightness measurement system (ISO 2470-2) is essentially the same as the previously described ISO system (ISO 2470-1) with the exception of the specified illuminant. D65 brightness uses the CIE standard illuminant D65, an outdoor (average north sky) daylight illuminant containing a significantly greater amount of UV energy than CIE illuminant C (as specified for ISO brightness measurement). Therefore, the additional UV energy emitted by the D65 standard illuminant will produce a greater fluorescence response when the paper contains optical brightening agents. Consequently, D65 brightness measurements will be significantly higher (when paper contains optical brightening agents) than those produced by the TAPPI T 452/GE or the ISO brightness methods which specify an illuminant with less UV content.

Brightness values greater than 100%: In response to demand for brighter “blue white” papers, fine paper manufacturers commonly add chemical compounds called optical brightening agents or fluorescent whitening agents (OBAs/FWAs) to commercial printing papers. These chemicals have the unique ability to absorb ultraviolet radiation and then transform and re-emit invisible UV wavelengths as high energy photons of light in the violet/blue area of the visible spectrum—a phenomenon called fluorescence. Invisible UV wavelengths such as contained in sunlight, ISO 3664:2009 standard lighting, and, to varying degrees in many artificial light sources, are therefore absorbed by optical brightening agents in fine printing papers and transformed into wavelengths of energy perceptible to human viewing. This transformed UV energy becomes “visible” light radiating from the paper's surface.

When illuminated by a light source containing a significant amount of U.V. energy, the energy transference process (from invisible to visible wavelengths) is activated and an optical brightener enhanced paper may actually reflect more total light than it receives from the light source (i.e., visible light reflected from the light source plus re-emitted “blue” light transferred from the invisible realm of the electromagnetic spectrum).

Since paper brightness is measured in the blue area of the visible spectrum (457 nm), the very region where the process of fluorescence redirects UV energy to become visible light, illuminants with high UV energy content (e.g., D65) can produce brightness measurements in excess of 100%. Fluorescence may be quantified with both directional and diffuse measurement systems. Measurements are made with and without the use of a UV-cut filter. A fluorescence value is then calculated from the mathematical difference between the UV included and UV excluded measurements.

In some embodiments, the constructions described herein exhibit a brightness measurement greater than or equal to about 80%, 85%, 90%, 91%, 92%, 93%, 94%, 95%, 96%, 97%, 98%, 99%, 100%, 101%, 102%, 103%, 104%, 105%, 106%, 107%; 108%, 109%, 110%, 111%, 112%, 113%, 114%, 115%, 116%, 117%, 118%, 119%, 120%, 121%, 122%, 123%, 124%, 125%, 126%, 127%, 128%, 129%, 130%, 131%, 132%, 133%, 134%, 135%, 136%, 137%, 138%, 139%, 140%, 141%, 142%, 143%, 144%, or 145% or greater.

### IV. Methods of Making Label Constructions

The constructions described herein can be manufactured using a variety of technique known in the art. In some embodiments, for example FIG. 1, the facestock is welded to the laminating foil using a suitable laminating adhesive. The white acrylic lacquered top coat is applied to the back side of the foil resulting in a white top sheet and a white bottom sheet. A pressure sensitive adhesive and a liner are then applied to arrive at the final construction.

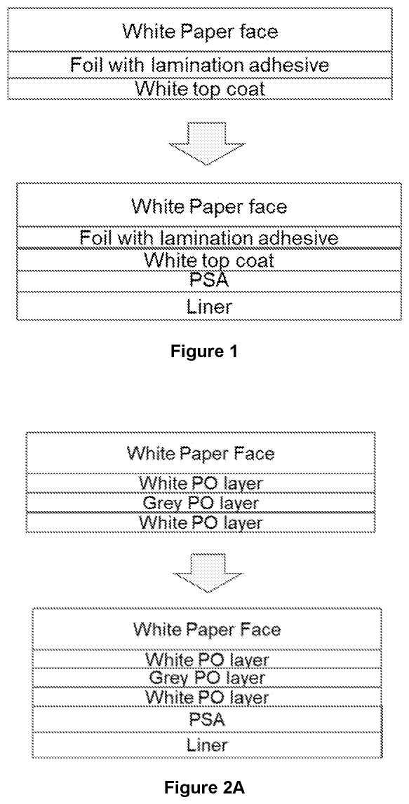

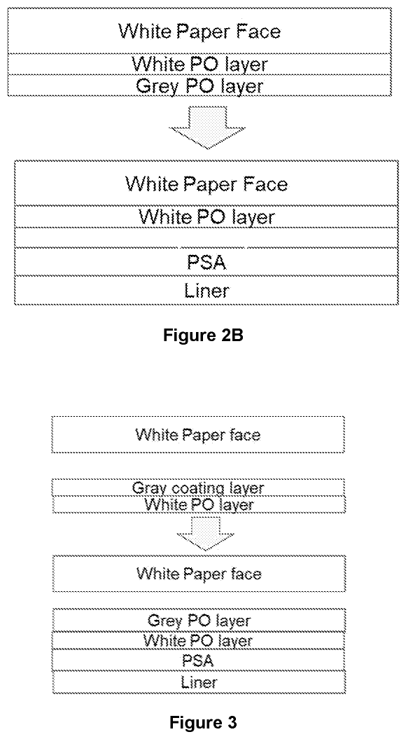

In some embodiments, for example FIG. 2, a single layer or multilayer polyolefin is extruded onto the facestock. A pressure sensitive adhesive and a liner are then applied to arrive at the final construction.

In some embodiments, for example FIG. 3, the face stock is welded to a double-sided film, optionally using a weld adhesive between the face stock and the gray layer. A pressure sensitive adhesive and a liner are then applied to arrive at the final construction.

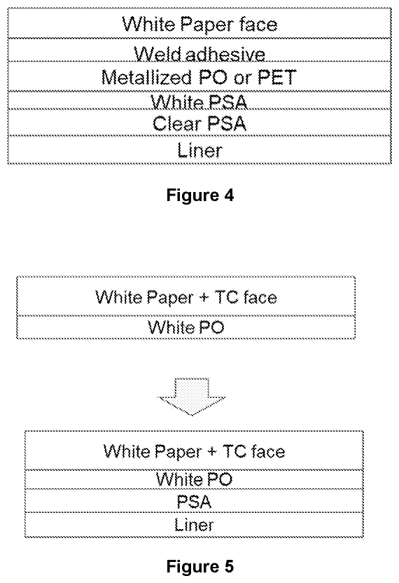

In some embodiments, for example FIG. 4, a white face stock is adhered to a metallized PO or PET layer (the PO or PET can be white or clear) using a weld adhesive. A white pressure sensitive adhesive, a clear pressure sensitive adhesive, and a liner are applied to arrive at the final construction.

In some embodiments, for example FIG. 5, a white polyolefin is extruded onto a white paper and topcoat face. A pressure sensitive adhesive layer and a liner are then applied to arrive at the final construction.

### IV. Applications

The label constructions described herein can be applied to any type of container. In some embodiments, the label constructions are applied to a container, such as a bottle, that are subjected to moisture during cooling (e.g., in a refrigerator or freezer) or being kept cool (e.g., in an ice bucket, cooler, etc.). In some embodiments, the bottle is a wine, spirits, and/or beer bottle.

### EXAMPLES

### Example 1. Manufacture of Prototype 1

Prototype 1 was manufactured by preparing a multilayer foil component containing a face sheet, an adhesive layer, and a metallic foil layer. The adhesive layer adheres the face sheet to the metallic foil layer. A topcoat (e.g., white acrylic lacquer) was coated onto the metallic foil layer. In some embodiments, the face sheet is white, resulting in a white top sheet and a white bottom sheet. An adhesive layer, such as PSA, is applied to the topcoat and then a liner is applied. A representation of prototype 1 is shown in FIG. 1.

### Example 2. Manufacture of Prototype 2

Prototype 2 was manufactured by applying an extruded multilayer polyolefin coating (e.g., trilayer: white polyethylene layer-grey polyethylene layer-white polyethylene layer) to a facestock, such as a paper. An adhesive layer, such as a PSA, was added to the coated facestock followed by a liner. In some embodiments, the multilayer polyolefin contains two layers: a grey polyethylene layer and a white polyethylene layer. A representation of prototype 2 is shown in FIG. 2.

### Example 3. Manufacture of Prototype 3

Prototype 3 was manufactured by welding a facestock to a two-layer film containing a grey coating layer and a white polyolefin (e.g., polypropylene). An adhesive layer, such as a PSA, was added to the coated face stock followed by a liner. A representation of prototype 3 is shown in FIG. 3.

### Example 4. Manufacture of Prototype 4

Prototype 4 was manufactured by welding a face stock to a metallized film using a weld adhesive. A dual die station was used to apply a white adhesive layer to one side of the face stock-metallized layer followed by application of an adhesive, such as a PSA. A liner was then added. A representation of prototype 4 is shown in FIG. 4.

### Example 5. Manufacture of Prototype 5

Prototype 5 was manufactured by coating a face layer containing a face stock, a topcoat, and a white polyolefin (e.g., polyethylene) layer. An adhesive layer, such as a PSA, was added to the coated face stock followed by a liner. A representation of prototype 5 is shown in FIG. 5.

### Example 6. Opacity Measurements of Various Facestocks

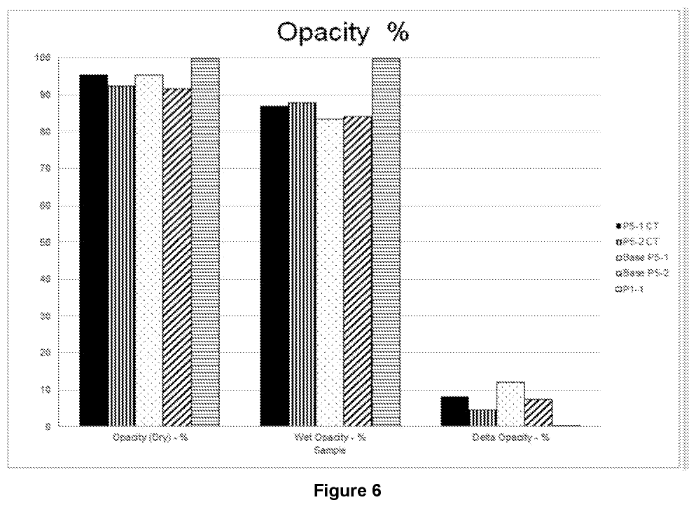

The opacity of the face stocks of 4 constructions of Prototype 5 and 1 construction of Prototype 1 were measured. The results are shown in FIG. 6. All 5 face stocks exhibited dry opacity greater than 90% with 2 of the face stocks of prototype 5 exhibiting a dry opacity of about 95%. The facestock of prototype 1 exhibited a dry opacity of 100%. The 4 face stocks of prototype 5 showed a wet opacity of between 80 and 90%. In contrast, the face stock of prototype 1 exhibited a wet opacity of 100%. The delta opacity of the face stocks of prototype 5 varied between 5 and 12% while the delta opacity for the facestock of prototype 1 was essentially 0. “Base” refers to uncoated base paper. The other face stocks are coated with a top coat, such as a water-based top coat.

### Example 7. Water Wicking Measurements of Various Face Stocks

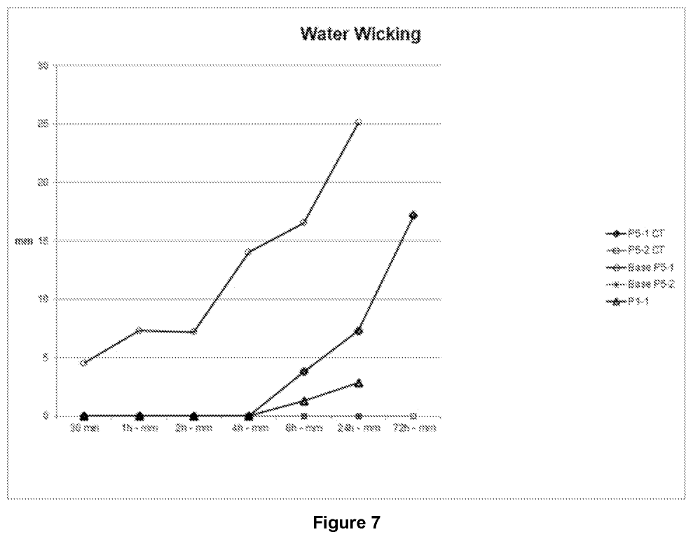

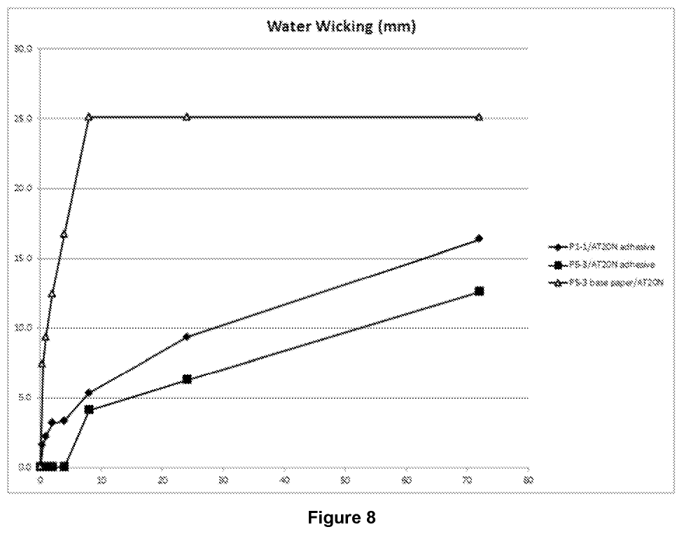

The water wicking ability of the face stocks evaluated in Example 6 were measured. The results are shown in FIG. 7. The incorporation of a topcoat (P5-1 vs. P5-1 CT) decreased the degree of water wicking. The face stock of prototype 1 showed no water intrusion after 72 hours and the addition of a topcoat did not change the performance.

### Example 8. Water Resistance and Opacity of Constructions of Prototype 1 and Prototype 5

The water wicking, opacity, and ice bucket performance of three constructions is shown in Table 1.

TABLE 1

| | Time | | | | | | | | Dry | Wet | Delta |
|---|---|---|---|---|---|---|---|---|---|---|---|
| | 0 | 1 | 1 | 2 | 4 | 8 | 24 | 72 | Opacity % | Opacity % | Opacity % |
| P1-1/AT20N adhesive | 0.0 | 1.66 | 2.25 | 3.19 | 3.38 | 5.34 | [symbol] | [symbol] | 99.97 | [symbol] | 0.44 |
| P5-3/AT20N adhesive | 0.0 | 0.00 | 0.00 | 0.00 | 0.00 | [symbol] | 5.28 | [symbol] | [symbol] | 89.19 | 2.80 |
| P5-3 base paper/AT20N | 0.0 | 7.47 | 9.14 | 12.44 | [symbol] | 25.10 | 25.10 | 25.10 | 92.53 | [symbol] | 23.07 |

[symbol]

indicates data missing or illegible when filed

“Base” refers to uncoated base paper. The other constructions were coated with a water-based topcoat. As shown in Table 1, the construction of prototype 1 exhibited better dry opacity, wet opacity, and delta opacity than the constructions of prototype 5. With respect to water resistance, the construction of P5-3 was slightly better than the construction P1-1. The data shows that the addition of a water-based topcoat improves the wet and dry opacity compare to uncoated base paper.

The water resistance described above is shown graphically in FIG. 8.

### Example 9. Ice Bucket Test of Constructions of Prototype 1 and 5

The results of the ice bucket test, opacity and the adhesive strength of the constructions in Example 8 were measured over time. The results are shown in Table 2.

TABLE 2

| Sample Identification | [symbol] | 1 Hour | 2 Hour | 3 Hour | 4 Hour | 5 Hour | 6 Hour | 7 Hour | 8 Hour |
|---|---|---|---|---|---|---|---|---|---|
| P1-1/AT2014 adhesive | Show through | [symbol] | [symbol] | [symbol] | [symbol] | [symbol] | [symbol] | [symbol] | [symbol] |
| | Edge Lift | [symbol] | [symbol] | [symbol] | [symbol] | [symbol] | [symbol] | [symbol] | [symbol] |
| | Adhesive | [symbol] | [symbol] | [symbol] | [symbol] | [symbol] | [symbol] | [symbol] | [symbol] |
| P5-3/AT2014 adhesive | Show through | [symbol] | [symbol] | [symbol] | [symbol] | [symbol] | [symbol] | [symbol] | [symbol] |
| | Edge Lift | [symbol] | [symbol] | [symbol] | [symbol] | [symbol] | [symbol] | [symbol] | [symbol] |
| | Adhesive | [symbol] | [symbol] | [symbol] | [symbol] | [symbol] | [symbol] | [symbol] | [symbol] |
| P5-3 base paper/AT20N | Show through | [symbol] | [symbol] | [symbol] | [symbol] | [symbol] | [symbol] | [symbol] | [symbol] |
| | Edge Lift | [symbol] | [symbol] | [symbol] | [symbol] | [symbol] | [symbol] | [symbol] | [symbol] |
| | Adhesive | [symbol] | [symbol] | [symbol] | [symbol] | [symbol] | [symbol] | [symbol] | [symbol] |

| | | |
|---|---|---|
| Edge Lift | Adhesion | Other Visual Attributes |

| | | | | |
|---|---|---|---|---|
| NEL= | NO Edge Lift | L= | Slight Adhesion | [symbol] |
| SL= | Slight Edge Lift | Mod= | Moderate Adhesion | [symbol] |
| MEL= | Moderate Edge Lift | T= | light Adhesion | Opacity [symbol] % of [symbol] |

| | | |
|---|---|---|
| EL= | Edge [symbol] Lift | [symbol] |

NOTE:
% of Edge lift is relative #Z,899; typically #Z,899;. [symbol]
indicates data missing or illegible when filed

“Base” refers to uncoated base paper (P5-3 base paper). The other constructions contain a water-based topcoat (P5-3). As shown above, the construction of prototype 1 (P1-1) exhibited no show through, no edge lift or slight edge lift, and tight adhesion over 8 hours. In contrast, the constructions of prototype 5 exhibited some show through after 3 hours (P5-3) or significant mottling at 1 hour (P5-3 base paper). P5-3 showed similar or slightly better edge lift and adhesive strength as P1-1 while P5-3 base paper showed markedly worse edge lift and adhesive strength compared to P1-1 and P5-3. The addition of a water-based topcoat improved show through, edge lift, and adhesive strength.

### Example 10. Properties of Constructions of Prototype 2

The whiteness, wet and dry opacity, and adhesive strength of constructions of FIG. 2 were measured. The results are shown in Table 3.

TABLE 3

| | Time (hour) | | | | | | | | Whiteness | Opacity | Opacity | Opacity | SC |
|---|---|---|---|---|---|---|---|---|---|---|---|---|---|
| | 0 | 0.5 | 1 | 2 | 4 | 8 | 24 | 72 | % | Dry % | Wet % | Delta | structure |
| Base paper P2-1 to P2-4 | 0 | 0.00 | [symbol] | 2.50 | [symbol] | 30.88 | 17.88 | 25.00 | 84.5 | [symbol] | 81.8 | 9.8 | None |
| P2-1 T5.8 | 0 | 0.00 | 0.85 | [symbol] | [symbol] | [symbol] | 10.13 | 36.88 | 90.3 | 97.1 | [symbol] | 7.0 | A/C/A |
| P2-2 T7.8 | 0 | 0.00 | 0.13 | 1.63 | [symbol] | [symbol] | [symbol] | 15.68 | 90.2 | [symbol] | [symbol] | 7.5 | A/C/A |
| P2-3 D7.8 | 0 | 1.00 | 3.00 | 1.88 | 2.88 | [symbol] | [symbol] | 15.88 | [symbol] | [symbol] | [symbol] | [symbol] | A/C |
| P2-4 D10 | 0 | 0.83 | 1.38 | 2.38 | 4.00 | 8.00 | 10.63 | 22.38 | [symbol] | 98.7 | [symbol] | 1.0 | A/C |

| Sample | | 1 Hour | 2 Hour | 4 Hour | 8 Hour | 24 Hour |
|---|---|---|---|---|---|---|
| Base paper P3-1 to P2-4 | Show Through | 75% | 100% | 100% | 100% | |
| | Label Shift | NA | NA | NA | NA | |
| | Adhesion | T | T | T | T | |
| | Edge Lift | NA | NA | NA | NA | |
| P2-3 T5.8 | Show Through | 100% | 100% | 100% | 100% | 100% |
| | Label Shift | NA | NA | NA | NA | |
| | Adhesion | T | T | T | T | L |
| | Edge Lift | MEL Bottom | MEL Bottom | MEL Bottom | MEL Bottom | MEL Bottom Channeling |
| P2-2 T7.8 | Show Through | [symbol] | 100% | 100% | 100% | 100% |
| | Label Shift | NA | NA | NA | NA | NA |
| | Adhesion | T | T | T | T | L |
| | Edge Lift | NA | NA | NA | NA | NA |
| P2-3 D7.8 | Show Through | 10% | 75% | 75% | 100% | 100% |
| | Label Shift | NA | NA | NA | NA | NA |
| | Adhesion | T | T | T | T | T |
| | Edge Lift | NA | NA | NA | NA | NA |
| P2-4 D10 | Show Through | [symbol] | 100% | 100% | 100% | 100% |
| | Label Shift | NA | NA | NA | NA | NA |
| | Adhesion | T | T | T | T | T |
| | Edge Lift | NA | NA | NA | NA | NA |

[symbol]

indicates data missing or illegible when filed

“Base” refers to uncoated base paper. The other constructions contain a double or triple polyolefin (polyethylene) layer having the coat weight specific in the construction name (e.g., T7.8 means triple layer having a coat weight of 7.8). The total extrusion (PE, white/gray or white/gray/white) coat weight is 17.8. All of the constructions performed better than the construction containing the base paper. For example, P1-1-P1-4 exhibited whiteness of at least 90%, dry opacity of at least 97%, and for 3 of the constructions, at least 98%, and wet opacity of at least 90%, and for 2 of the construction, at least 95% and 97%. P1-4 exhibited the lowest delta opacity.

All of the constructions showed similar values for show through, adhesion strength, and label shift. However, P2-2-P2-4 exhibit better edge lift that P2-1.

### Example 11. Water Resistance of Constructions of FIG. 2

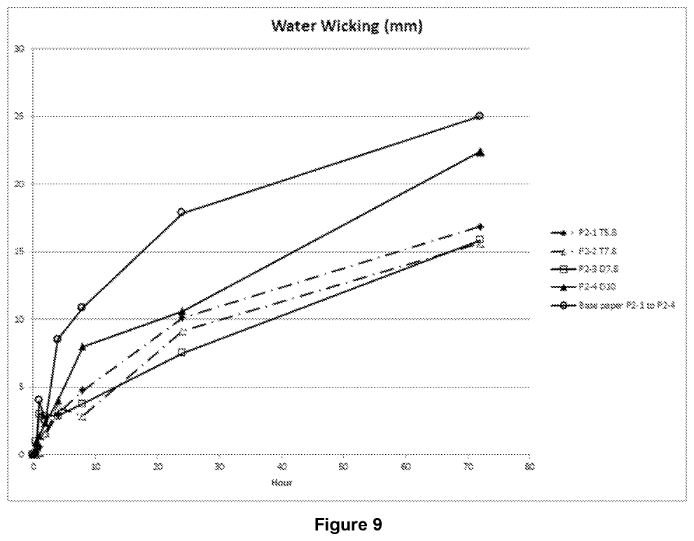

The water resistance of constructions of prototype 2 were measured. The results are shown in FIG. 9. The construction with the uncoated base paper exhibited the most water intrusion. The construction of prototype P2-3 exhibited the least water intrusion over 72 hours.

### Example 12. Properties of Constructions of FIG. 2

The whiteness, wet and dry opacity, and adhesive strength of constructions of FIG. 2 were measured. The results are shown in Table 4.

TABLE 4

| | Time (hour) | | | | | | | | Whiteness | Opacity | Opacity | Opacity | SC |
|---|---|---|---|---|---|---|---|---|---|---|---|---|---|
| | 0 | 0.5 | 1 | 2 | 4 | 8 | 24 | 72 | % | Dry % | Wet % | Delta | structure |
| Base paper P2-5 to P2-8 | 0 | 0 | 0 | 0 | 0 | 0 | 0 | 0 | 76.8 | 91.9 | 87.3 | 4.6 | None |
| P2-5 T5.8 | 0 | 0 | 0 | 0 | 0 | 0 | 0 | 0 | 79.2 | 97.3 | 93.7 | [symbol] | A/C/A |
| P2-6 T7.8 | 0 | 0 | 0 | 0 | 0 | 3.125 | [symbol] | 2.5 | 79.7 | 98.0 | 96.4 | 1.6 | A/C/A |
| P2-7 D7.8 | 0 | 0 | 0 | 0 | 0 | [symbol] | 0 | 0 | 78.9 | 98.5 | 97.9 | [symbol] | A/C |
| P2-8 D10 | 0 | 0 | 0 | 0 | 0 | 0 | 0 | 0 | 78.7 | 98.4 | [symbol] | [symbol] | A/C |

[symbol]

indicates data missing or illegible when filed

“Base” refers to a construction containing untreated base paper. “T” or “D” refers to double or triple extruded layers of a polyolefin (PO), e.g., polyethylene (PE). The number indicates the coat weight of the extruded PO layers. The constructions all exhibited similar whiteness values. P2-5-P2-8 exhibited dry opacity greater than 97% and 98% and wet opacity greater than 93%, 96%, and 97%. The delta opacity was lowest for P2-7 with P2-6 and P208 having similar delta opacity values.

### Example 13. Opacity and Adhesive Strength of Constructions of Prototype 2

The opacity and the adhesive strength of the constructions of Prototype 2 were measured over time. The results are shown in Table 5.

TABLE 5

| Sample | | 1 Hour | 2 Hour | 4 Hour | 8 Hour | 24 Hour |
|---|---|---|---|---|---|---|
| Base paper P2-5 to P2-8 | Show Through | 0% | 0% | 0% | 0% | |
| | Label Shift | Channeling | Channeling | Channeling | Channeling | |
| | Adhesion | MOD | MOD | MOD | MOD | |
| | Edge Lift | NA | NA | NA | NA | |
| P2-5 T5.8 | Show Through | 25% | 50% | 50% | 50% | 50% |
| | Label Shift | NA | NA | NA | NA | NA |
| | Adhesion | T | T | T | T | T |
| | Edge Lift | MEL Bottom | MEL Bottom | MEL Bottom | MEL Bottom | MEL Bottom |
| P2-6 T7.8 | Show Through | 0% | 0% | 0% | 0% | 0% |
| | Label Shift | NA | NA | NA | NA | NA |
| | Adhesion | T | T | T | T | T |
| | Edge Lift | MEL Bottom | MEL Bottom | MEL Bottom | MEL Bottom | MEL Bottom |
| P2-7 D7.8 | Show Through | 0% | 0% | 0% | 0% | 0% |
| | Label Shift | NA | NA | NA | NA | NA |
| | Adhesion | T | T | T | T | T |
| | Edge Lift | NA | NA | NA | NA | NA |
| P2-8 D10 | Show Through | 0% | 0% | 0% | 0% | |
| | Label Shift | Channeling | Channeling | Channeling | Channeling | |
| | Adhesion | MOD | MOD | MOD | MOD | |
| | Edge Lift | NA | NA | NA | NA | |

The base paper construction showed channeling and moderate adhesive strength. P2-5-P2-7 did not exhibit label shift and all exhibited tight adhesion. P2-5 and P2-6 exhibited moderate edge lift while P2-7 exhibited no edge lift. P2-8 exhibited channeling and moderate adhesion.

### Example 14. Opacity and Whiteness/Brightness of Constructions of Prototype 2

The opacity and whiteness/brightness for constructions of Prototype 2 were measured. The results are shown in Table 6. The base paper construction showed channeling and moderate adhesive strength. P2-5-P2-7 did not exhibit label shift and all exhibited tight adhesion. P2-5 and P2-6 exhibited moderate edge lift while P2-7 exhibited no edge lift. P2-8 exhibited channeling and moderate adhesion. P2-9-P2-12 exhibit similar label shift, adhesive strength, and edge lift.

TABLE 6

| | Time (hour) | | | | | | | | Whiteness | Brightness | Opacity | Opacity | Opacity | SC |
|---|---|---|---|---|---|---|---|---|---|---|---|---|---|---|
| | 0 | 0.5 | 1 | 2 | 4 | 8 | 24 | 72 | % | % | Dry % | Wet % | Delta | structure |
| Base paper P2-9 to P2-14 | 0 | 0.00 | 0.00 | [symbol] | 1.25 | 1.13 | 4.00 | [symbol] | #Z,899 | [symbol] | 90.4 | [symbol] | 11.5 | None |
| P2-8 T5.8 | 0 | 0.00 | 0.18 | [symbol] | [symbol] | 1.83 | 5.00 | 8.75 | [symbol] | 87.7 | 86.8 | 88.7 | 8.0 | A/C/A |
| P2-10 T7.8 | 0 | [symbol] | 0.00 | [symbol] | [symbol] | 0.00 | 7.50 | [symbol] | [symbol] | [symbol] | 97.3 | 84.2 | 18.1 | A/C/A |
| P2-11 D7.8 | 0 | 0.00 | [symbol] | 0.00 | [symbol] | 0.03 | [symbol] | [symbol] | [symbol] | [symbol] | [symbol] | [symbol] | [symbol] | A/C |
| P2-12 D10 | 0 | 0.00 | 0.00 | 0.00 | [symbol] | 0.00 | [symbol] | [symbol] | [symbol] | [symbol] | [symbol] | [symbol] | [symbol] | A/C |

[symbol]

indicates data missing or illegible when filed

The extrusion coated constructions exhibit improved whiteness compared to the base papers. Dry opacity for the coated constructions was at least 96%, 97%, and 98%. Wet opacity was at least 80%, and for P2-11 and P2-12 greater than 94% and 95%. Delta opacity was lowest for P2-11 and P2-12.

### Example 15. Water Resistance of Constructions of Prototype 2

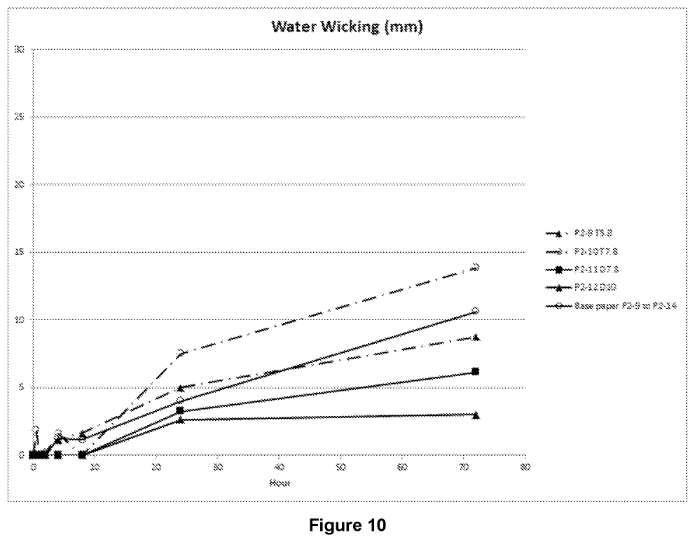

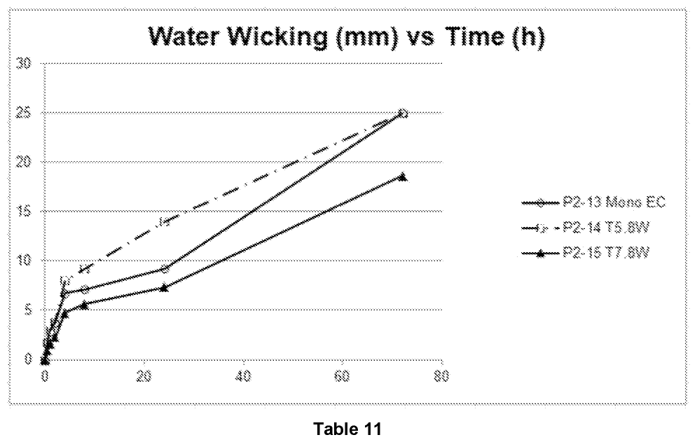

The water resistance of constructions of Prototype 2 were measured. The results are shown in FIG. 10. The base paper exhibited the most water intrusion while P2-12 D10 exhibited the least amount of water intrusion over 72 hours. Base paper, P2-11 and P2-12 exhibited similar water intrusion over the first 8 hours.

### Example 16. Water Resistance of Constructions of Prototype 2

The water resistance of constructions of Prototype 2 were measured. The results are shown in FIG. 11. P2-15 exhibited the lowest water intrusion over 72 hours.

### Example 17. Whiteness and Opacity of Constructions of Prototype 2

The water resistance of constructions of Prototype 2 were measured. The results are shown in Table 7.

TABLE 7

| | Time (h) | | | | | | | | Whiteness | Opacity | Opacity | Opacity | EC |
|---|---|---|---|---|---|---|---|---|---|---|---|---|---|
| | 0 | 0.5 | 1 | 2 | 4 | 8 | 24 | 72 | % | Dry % | Wet % | Delta | structure |
| P2-13 Mono EC | 0 | 1.875 | 2.875 | 3.75 | 6.75 | 7.125 | 9.25 | 25 | 107 | 96.1 | 86.5 | 9.6 | A |
| P2-14 T5.8W | 0 | 1.75 | 3 | 3.875 | 8 | 9.25 | 14 | 25 | 109 | 97.4 | 89.0 | 8.4 | A/C/A |
| P2-15 &7.8W | 0 | 1 | 1.625 | 2.25 | 4.75 | 5.625 | 7.375 | 18.625 | 108 | 98.1 | 92.0 | 8.1 | A/C/A |

The constructions exhibited similar whiteness values. Dry opacities were also similar. However, P2-15 exhibited a higher wet opacity value and the lowest delta opacity.

### Example 18. Ice Bucket Performance of Constructions of Prototype 2

The ice bucket performance of constructions of Prototype 2 was measured. The results are shown in Table 8.

TABLE 8

| Samples | | 1 Hour | 2 Hour | 4 Hour | 8 Hour | 24 Hour |
|---|---|---|---|---|---|---|
| P2-13 Mono EC | Show Through/Opacity | B < 25% | C < 25-50% | C < 25-50% | C < 25-50% | C < 25-50% |
| | Dart/Channel Length | A-0%/B < 25% | A-0%/B < 25% | A-0%/B < 25% | A-0%/B < 25% | A-0%/B < 25% |
| | Dart/Channel Width | B < 25% | B < 25% | B < 25% | B < 25% | B < 25% |
| | Edge Lift | A-0% | A-0% | A-0% | A-0% | A-0% |
| | Tightness | A- Tight 0% | A- Tight 0% | A- Tight 0% | A- Tight 0% | A- Tight 0% |
| | Scratch Rating | N/A | N/A | N/A | N/A | N/A |
| P2-14 T5.8W | Show Through/Opacity | C < 25-50% | D > 50% | D > 50% | D > 50% | D > 50% |
| | Dart/Channel Length | A-0%/B < 25% | A-0%/B < 25% | A-0%/B < 25% | A-0%/B < 25% | A-0%/B < 25% |
| | Dart/Channel Width | A-0% | A-0% | A-0% | A-0% | A-0% |
| | Edge Lift | A-0% | A-0% | A-0% | A-0% | A-0% |
| | Tightness | A- Tight 0% | A- Tight 0 % | A- Tight 0% | A- Tight 0% | A- Tight 0% |
| | Scratch Rating | N/A | N/A | N/A | N/A | N/A |
| P2-15 T7.8W | Show Through/Opacity | B < 25% | B < 25% | B < 25% | B < 25% | B < 25% |
| | Dart/Channel Length | A-0% | A-0% | A-0% | A-0% | A-0% |
| | Dart/Channel Width | A-0% | A-0% | A-0% | A-0% | A-0% |
| | Edge Lift | A-0% | A-0% | A-0% | A-0% | A-0% |
| | Tightness | A- Tight 0% | A- Tight 0% | A- Tight 0% | A- Tight 0% | A- Tight 0% |
| | Scratch Rating | N/A | NA | NA | NA | NA |

Show Through/Opacity Length/Width/Lift Legend

| | |
|---|---|
| A | 0% |
| B | <25% |
| C | 25-50% |
| D | >50% |

Slipping/Adhesion Legend

| | |
|---|---|
| A | Tight 0% movement |
| B | Slight <25% movement |
| C | Moderate 25-50% movement |
| D | Float Off |

P2-15 exhibited the best performance with respect to opacity, channeling, edge lift, and adhesion tightness.

1. A multilayer label construction comprising:
a. a face sheet comprising paper;
b. a first white polyolefin layer adjacent to the face sheet;
c. a grey polyolefin layer adjacent to the white polyolefin layer;
d. a second white polyolefin layer adjacent to the grey polyolefin layer;
e. an adhesive layer adjacent to the second white polyolefin layer; and
f. a liner.

2. The construction of claim 1, wherein the paper comprises a cellulosic or natural paper.

3. The construction of claim 1, wherein the paper comprises a synthetic paper.

4. The construction of claim 2, wherein the first white polyolefin layer comprises polyethylene.

5. The construction of claim 4, wherein the grey polyolefin layer comprises polyethylene.

6. The construction of claim 5 wherein the second white layer comprises polyethylene.

7. The construction of claim 6, wherein the first white layer, the gray layer, and the second white layer are extruded onto the paper.

8. The construction of claim 6, wherein the construction does not contain a weld adhesive between the and the first white layer.

9. The construction of claim 6, wherein the adhesive layer comprises a pressure-sensitive adhesive.

10. The construction of claim 9, wherein the pressure-sensitive adhesive comprises an acrylic-based polymer or an acrylate polymer or copolymer.

11. The construction of claim 6, wherein the dry opacity is greater than or equal to 97%.

12. The construction of claim 11, wherein the wet opacity is greater than or equal to 89%.

13. The construction of claim 6, wherein the dry opacity is greater than or equal to 98%.

14. The construction of claim 13, wherein the wet opacity is greater than or equal to 92%

15. The construction of claim 12, wherein the delta opacity is less than or equal to 8.5%.

16. The construction of claim 14, wherein the delta opacity is less than or equal to 6.5%.

17. The construction of claim 16, wherein the construction exhibits less than about 25% show through after 2 hours.

18. The construction of claim 16, wherein the construction exhibits about 0% dart/channel length for a period of time from about 1 to about 24 hours.

19. The construction of claim 16, wherein the construction exhibits about 0% dart/channel width for a period of time from about 1 to about 24 hours.

20. The construction of claim 9, wherein the construction consists essentially of
a. the face sheet comprising paper;
b. the first white polyolefin layer adjacent to the face sheet;
c. the grey polyolefin layer adjacent to the white polyolefin layer;
d. the second white polyolefin layer adjacent to the grey polyolefin layer;
e. the adhesive layer adjacent to the second white polyolefin layer; and
f. the liner.
